(19) United States
(12) Patent Application Publication
(10) Pub. No.: US 2016/0126808 A1
(43) Pub. Date: May 5, 2016

(54) DRIVING DEVICE AND VEHICLE WITH THE SAME

(71) Applicant: KABUSHIKI KAISHA YASKAWA DENKI, Kitakyushu-shi (JP)

(72) Inventors: Toshio NAGAO, Kitakyushu-shi (JP); Tetsuya ITO, Kitakyushu-shi (JP); Kazuo MIURA, Kitakyushu-shi (JP)

(73) Assignee: KABUSHIKI KAISHA YASKAWA DENKI, Kitakyushu-shi (JP)

(21) Appl. No.: 14/867,017

(22) Filed: Sep. 28, 2015

(30) Foreign Application Priority Data
Oct. 31, 2014 (JP) 2014-223412

(51) Int. Cl. H02K 9/19; H02K 5/20; H02K 3/28; H02K 11/00

(52) U.S. Cl. CPC H02K 9/19; H02K 11/0094; H02K 5/20; H02K 11/001; H02K 3/28

(57) ABSTRACT

A driving device according to one aspect of the present disclosure includes: a motor including a winding wire; a first cooler configured to cool the motor; and a power converter coupled to the motor. The motor, the first cooler, and the power converter are arranged in this order along a first direction.

### CROSS-REFERENCE TO RELATED APPLICATION

This application claims priority from Japanese Patent Application No. 2014-223412 filed with the Japan Patent Office on Oct. 31, 2014, the entire content of which is hereby incorporated by reference.

### BACKGROUND

1. Technical Field

The present disclosure relates to a driving device and a vehicle with the driving device.

2. Description of the Related Art

In recent years, there has been progress in the development of automobiles that less affect the environment and contribute to energy saving, for example, hybrid vehicles, electric vehicles, and fuel cell vehicles. These automobiles run using DC power supplies such as batteries, inverters, and motors as power sources. The inverter converts the DC power taken out from the DC power supply into an AC power to supply this AC power to the motor. JP-A-2005-224008 discloses a driving device where an inverter and a motor are integrated.

### SUMMARY

A driving device according to one aspect of the present disclosure includes: a motor including a winding wire; a first cooler configured to cool the motor; and a power converter coupled to the motor. The motor, the first cooler, and the power converter are arranged in this order along a first direction.

### BRIEF DESCRIPTION OF THE DRAWINGS

FIG. 1 is a perspective view schematically illustrating an electric vehicle as one example of a vehicle according to this embodiment;

FIG. 2 is a block diagram schematically illustrating the configuration of the electric vehicle as one example of the vehicle according to this embodiment;

FIG. 3 is a perspective view of a driving device viewed from a winding-wire switching/housing portion side;

FIG. 4 is a perspective view of the driving device viewed from a motor housing portion side;

FIG. 5 is a side view of the driving device viewed from an arrow A direction in FIG. 3;

FIG. 6 is a side view of the driving device viewed from an arrow B direction in FIG. 3;

FIG. 7 is a cross-sectional view taken along the line VII-VII in FIG. 3;

FIG. 8 is an exploded perspective view of the winding-wire switching/housing portion and the motor housing portion;

FIG. 9 is an exploded perspective view of a winding-wire switcher and its housing case viewed from the winding-wire switcher side;

FIG. 10 is an exploded perspective view of the winding-wire switcher and its housing case viewed from the housing case side;

FIG. 11 is an exploded perspective view of an inverter housing portion;

FIG. 12 is an exploded perspective view of the inverter housing portion in a vertically inverted state of FIG. 11;

FIG. 13 is an exploded perspective view of a terminal unit;

FIGS. 14A to 14C are graphs for describing the relationship between a torque and a rotation speed of the driving device; and

FIG. 15 is a cross-sectional view of the driving device according to another example.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The embodiment of the present disclosure will be described with reference to the drawings. This embodiment below is an example for describing the technique of the present disclosure, and does not limit the present disclosure to the following content. In the description in this embodiment, like reference numerals designate corresponding or identical elements or elements with corresponding or identical functions, and the duplicated descriptions will be omitted.

### [1] Schematic Configuration of Electric Vehicle

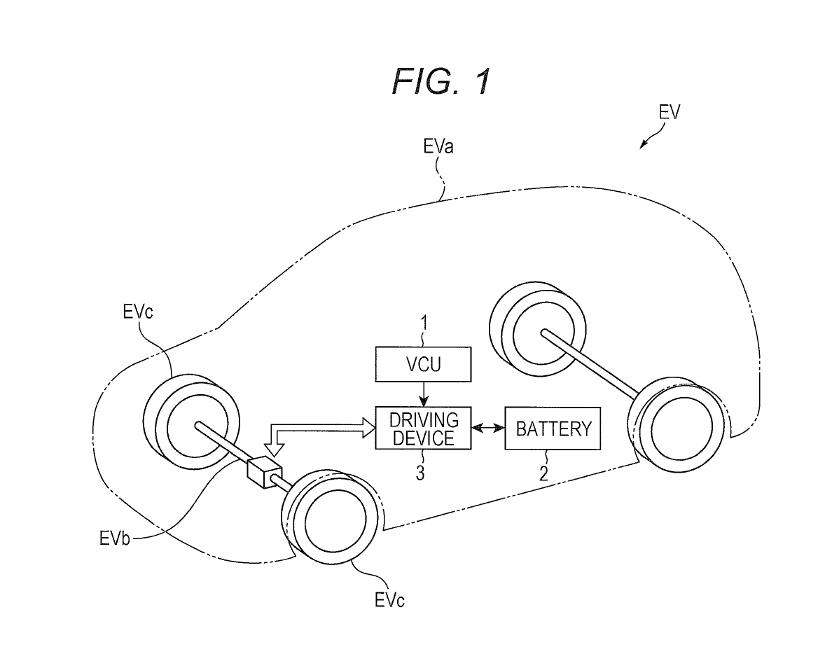

A description will be given of an electric vehicle EV as one example of a vehicle according to this embodiment with reference to FIG. 1. The electric vehicle EV includes a vehicle main body EVa, a vehicle control unit (VCU) 1, a battery (DC power supply) 2, and a driving device 3.

The battery 2 is a secondary battery capable of charging and discharging a DC power. The battery 2 can employ, for example, a lithium-ion battery. The driving device 3 is coupled to an axle shaft EVb (load) of the vehicle main body Eva. The driving device 3 drives the axle shaft EVb to cause rotations of drive wheels EVc which are disposed on both ends of the axle shaft EVb. Accordingly, the electric vehicle EV runs (advances or retreats).

### [2] Circuit Configuration of Driving Device

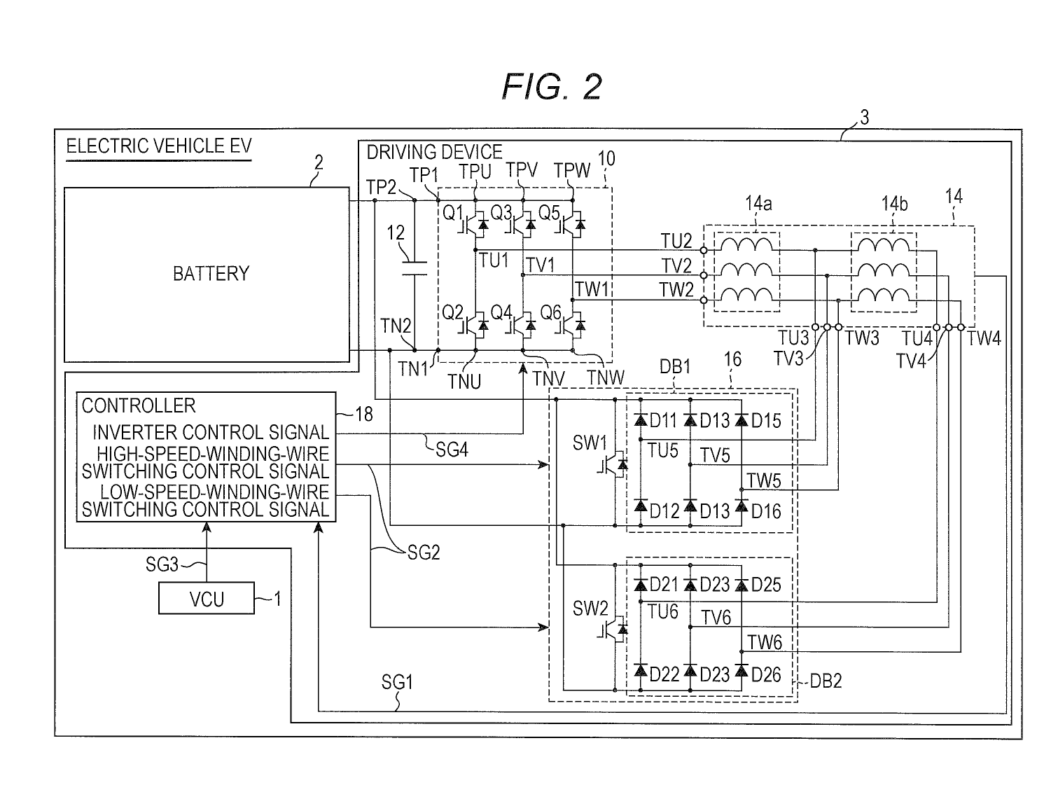

The following mainly describes the circuit configuration of the driving device 3 with reference to FIG. 2. The driving device 3 includes an inverter unit (power converter) 10, a capacitor 12, a motor 14, a winding-wire switcher 16, and a controller 18.

The inverter unit 10 includes an inverter circuit (one example of a power converter circuit). The inverter circuit is configured to convert the DC power input from the battery 2 into an AC power in three phases (the U-phase, the V-phase, and the W-phase) and output this AC power to the motor 14. The inverter unit 10 has terminals TP1 and TN1, which are coupled to the battery 2, and terminals TU1, TV1, and TW1, which are coupled to the motor 14. The terminals TP1 and TN1 of the inverter unit 10 couple to respective terminals TP2 and TN2 of the capacitor 12. The capacitor 12 has a function that further stabilizes the DC power input from the battery 2 to the inverter unit 10.

The inverter unit 10 has switch elements Q1 to Q6 for power conversion. The switch elements Q1 and Q2 perform power conversion in the U-phase. The switch elements Q3 and Q4 perform power conversion in the V-phase. The switch elements Q5 and Q6 perform power conversion in the W-phase. The respective switch elements Q1 to Q6 are constituted by, for example, semiconductors.

The motor 14 is rotatably driven based on the three-phase AC power supplied from the inverter unit 10. The motor 14 includes a three-phase winding wire 14a (a first winding wire, a high-speed drive winding wire) for high-speed driving and a three-phase winding wire 14b (a second winding wire, a low-speed drive winding wire) for low-speed driving.

The winding wires 14a and 14b are electrically connected in series. One end side of the winding wire 14a couples to terminals TU2, TV2, and TW2 corresponding to the respective phases (the U-phase, the V-phase, and the W-phase). The terminals TU2, TV2, and TW2 couple to the respective terminals TU1, TV1, and TW1 of the inverter unit 10.

One end side of the winding wire 14b couples to terminals TU4, TV4, and TW4 corresponding to the respective phases (the U-phase, the V-phase, and the W-phase). The respective phases (the U-phase, the V-phase, and the W-phase) on the other end side of the winding wire 14a electrically connect to the respective phases (the U-phase, the V-phase, and the W-phase) on the other end side of the winding wire 14b. Between the other end side of the winding wire 14a and the other end side of the winding wire 14b, the terminals TU3, TV3, and TW3 corresponding to the respective phases (the U-phase, the V-phase, and the W-phase) are coupled.

The winding-wire switcher 16 includes a winding-wire switching circuit. This winding-wire switching circuit includes diode bridges DB 1 and DB2 and switch elements SW1 and SW2. The diode bridge DB1 is electrically connected in parallel to the switch element SW1. The diode bridge DB1 has terminals TU5, TV5, and TW5. The respective terminals TU5, TV5, and TW5 couple to the terminals TU3, TV3, and TW3 of the motor 14.

The diode bridge DB1 includes six diodes D11 to D16. The diodes D11 to D16 rectify the three-phase (U-phase, V-phase, and W-phase) AC currents output from the terminals TU3, TV3, and TW3 of the motor 14. The diodes D11 and D12 rectify the U-phase AC current. The diodes D13 and D14 rectify the V-phase AC current. The diodes D15 and D16 rectify the W-phase AC current.

The diode bridge DB2 is electrically connected in parallel to the switch element SW2. The diode bridge DB2 has terminals TU6, TV6, and TW6. The respective terminals TU6, TV6, and TW6 couple to the terminals TU4, TV4, and TW4 of the motor 14.

The diode bridge DB2 includes six diodes D21 to D26. The diodes D21 to D26 rectify the three-phase (U-phase, V-phase, and W-phase) AC currents output from the terminals TU4, TV4, and TW4 of the motor 14. The diodes D21 and D22 rectify the U-phase AC current. The diodes D23 and D24 rectify the V-phase AC current. The diodes D25 and D26 rectify the W-phase AC current.

The switch element SW1 functions as a switch for switching to the high-speed winding wire to short-circuit the terminals TU3, TV3, and TW3 of the motor 14. The switch element SW2 functions as a switch for switching to the low-speed winding wire to short-circuit the terminals TU4, TV4, and TW4 of the motor 14. The switch elements SW1 and SW2 are constituted by, for example, semiconductors.

When the switch element SW1 short-circuits the terminals TU3, TV3, and TW3, in the winding wire 14a, the lead wire between the terminals TU2 and TU3, the lead wire between the terminals TV2 and TV3, and the lead wire between the terminals TW2 and TW3 are connected together. When the switch element SW2 short-circuits the terminals TU4, TV4, and TW4, in the winding wires 14a and 14b, the lead wire between the terminals TU2 and TU4, the lead wire between the terminals TV2 and TV4, and the lead wire between the terminals TW2 and TW4 are connected together. That is, the winding-wire switcher 16 has a function for switching the connection state of the winding wires 14a and 14b of the motor 14.

The controller 18 couples to the VCU 1. The controller 18 includes a control circuit. The control circuit is configured to output a control signal (an inverter control signal, a high-speed-winding-wire switching control signal, and a low-speed-winding-wire switching control signal) to the inverter unit 10 and the winding-wire switcher 16. The controller 18 controls switching of the switch elements Q1 to Q6 of the inverter unit 10, and controls switching of the switch elements SW1 and SW2 of the winding-wire switcher 16.

### [3] Specific Configuration of Driving Devices

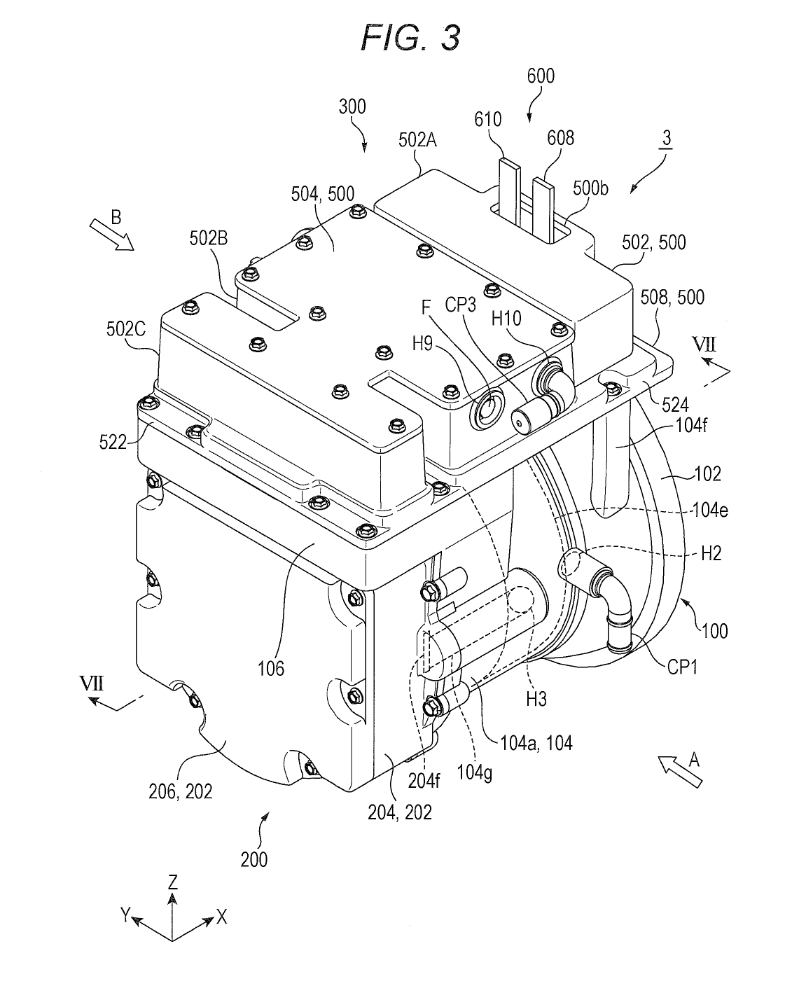

The following describes the specific configuration of the driving device 3 with reference to FIGS. 3 to 13. The driving device 3 includes a motor housing portion 100, a winding-wire switching/housing portion 200, and an inverter housing portion 300.

### [3.1] Motor Housing Portion

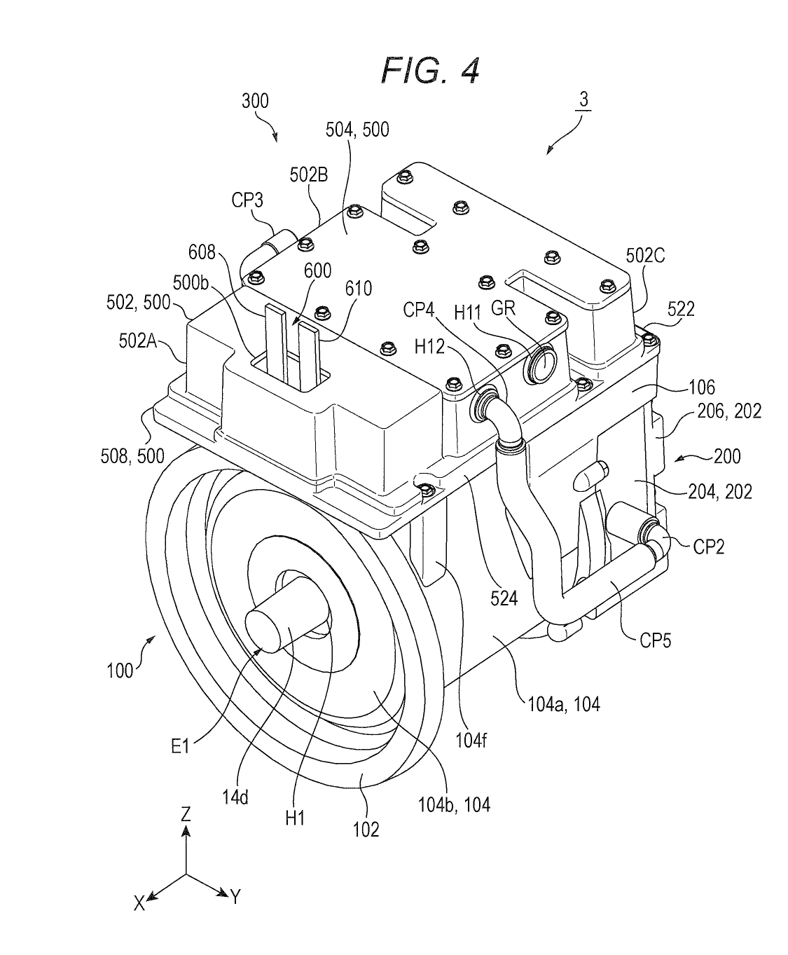

As illustrated in FIGS. 3 to 8, the motor housing portion 100 has a housing case (a first housing portion) 102 and the motor 14. The housing case 102 includes a main body portion 104 and a coupling portion (a first coupling portion) 106. The main body portion 104 includes a cylinder body 104a, which has an approximately cylindrical shape, an end wall 104b, which is arranged on one end side of the cylinder body 104a, and an end wall 104c, which is arranged on the other end side of the cylinder body 104a (see FIGS. 4, 7, and 8). The housing case 102 (the main body portion 104) houses the motor 14 within the housing space surrounded by the cylinder body 104a, the end wall 104b, and the end wall 104c. The housing case 102 internally houses the motor 14 such that an end E1 (described later) of a motor shaft 14d projects outward.

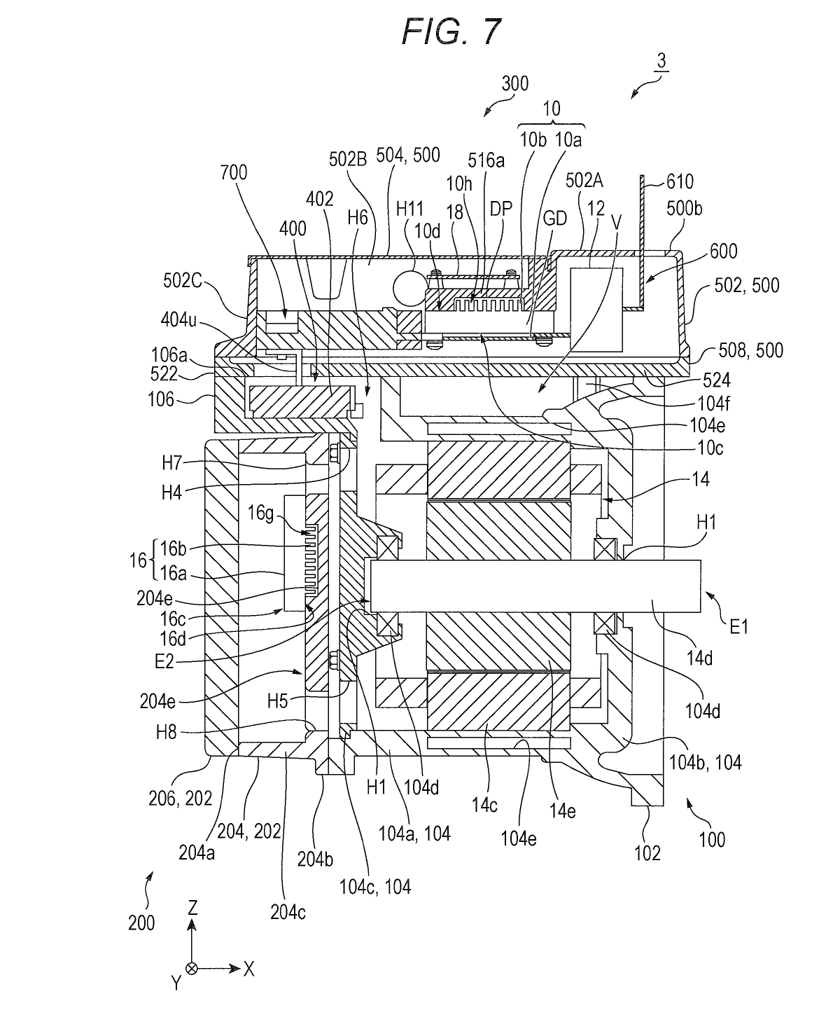

As illustrated in FIG. 7, to the inner wall of the cylinder body 104a, a stator 14c of the motor 14 is secured. As illustrated in FIGS. 4, 7, and 8, through-holes H1 are formed in the respective regions intersecting with the central axis of the main body portion 104 in the end walls 104b and 104c. As illustrated in FIG. 7, on these through-holes H1, the motor shaft 14d of the motor 14 is mounted through bearings 104d. Accordingly, the motor shaft 14d extends approximately in the identical direction to the central axis of the main body portion 104. Hereinafter, the extending direction of the motor shaft 14d is sometimes referred to as the “X-axis direction.”

The end E1 (see FIGS. 4 to 7) on the end wall 104b side in the motor shaft 14d is exposed to the outer side of the main body portion 104 from the through-hole H1 of the end wall 104b. The end E1 of the motor shaft 14d couples to the axle shaft EVb of the electric vehicle EV. Accordingly, the end E1 of the motor shaft 14d is a load-side end that couples to an external load such as the axle shaft EVb and the drive wheel EVc. On the other hand, the end E2 (see FIG. 7) on the end wall 104c side in the motor shaft 14d is the end (the other end) on the opposite side to the load. In the periphery of the motor shaft 14d, a rotor 14e is mounted. The rotor 14e is positioned on the inner side of the stator 14c.

As illustrated in FIGS. 3, 5, and 8, the cylinder body 104a has a flow passage (a first cooler) 104e where a cooling liquid (refrigerant) circulates. That is, the housing case 102 has the flow passage 104e. The flow passage 104e is formed inside the wall of the cylinder body 104a to surround the motor 14. In the cylinder body 104a, through-holes H2 and H3 are formed to communicate between the flow passage 104e and the outside. The through-hole H2 couples to a cooling pipe CP1. In the state where the driving device 3 is mounted on the electric vehicle EV, the cooling pipe CP1 couples to, for example, the radiator of the electric vehicle EV. The through-hole H3 is coupled to a flow passage 104g disposed on the peripheral wall of the cylinder body 104a. The flow passage 104g extends toward the winding-wire switching/housing portion 200 in the X-axis direction.

On the outer periphery surface of the cylinder body 104a, as illustrated in FIGS. 3 to 8, a plurality of support pillars 104f is disposed. The support pillar 104f is the member for supporting the inverter housing portion 300. The support pillar 104f is positioned on the end E1 side of the motor shaft 14d on the outer periphery surface of the cylinder body 104a. The support pillar 104f extends in the direction perpendicular to the X-axis direction, and in the direction toward the inverter housing portion 300. Hereinafter, the extending direction of the support pillar 104f is referred to as the “Z-axis direction.”

On the end wall (bracket) 104c, as illustrated in FIG. 7, through-holes H4 and H5 are formed. On the end wall 104c, the through-holes H4, H1, and H5 are arranged in this order in the Z-axis direction. That is, the through-hole H1 is positioned between the through-holes H4 and H5. The through-hole H4 is positioned biased to the inverter housing portion 300 relative to the through-hole H1. The through-hole H5 is positioned on the side away from the inverter housing portion 300 relative to the through-hole H1.

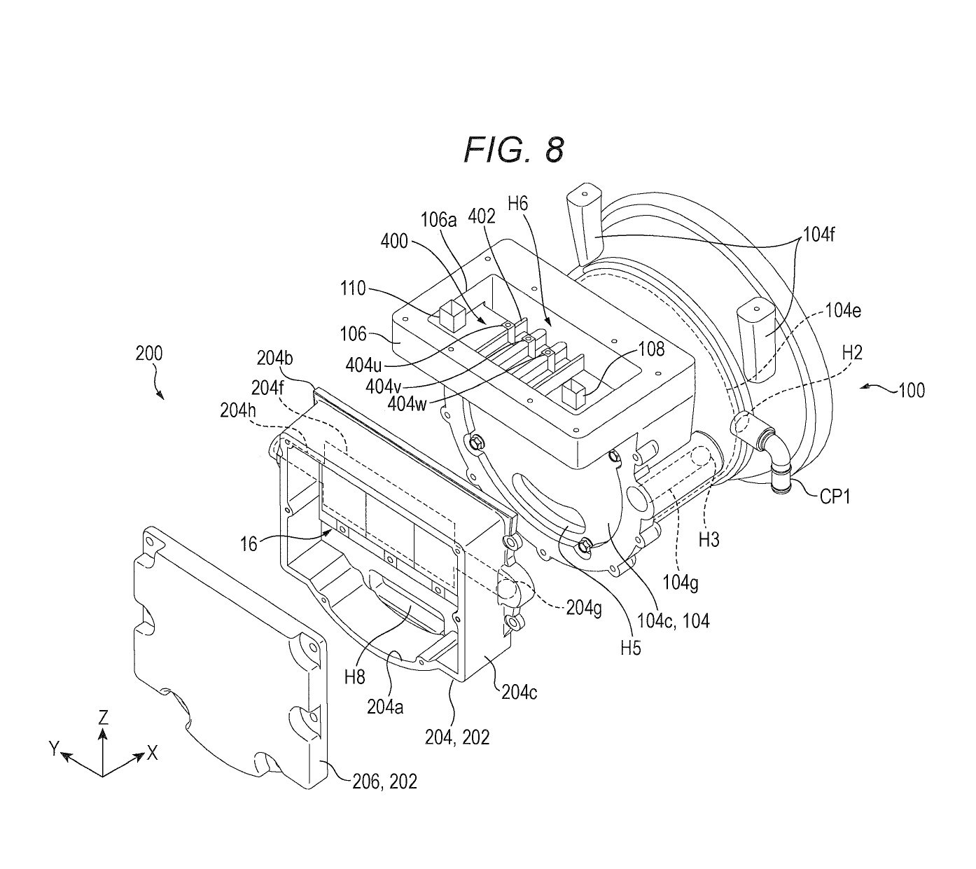

As illustrated in FIGS. 3 to 8, the coupling portion 106 is disposed on the outer periphery surface of the cylinder body 104a. The coupling portion 106 is positioned on the end E2 side of the motor shaft 14d and the inverter housing portion 300 side on the outer periphery surface of the cylinder body 104a. The coupling portion 106 has a bottomed cylindrical shape, and has an opening portion (a first opening portion) 106a (see FIGS. 7 and 8), which is opened toward the outer side. That is, the opening portion 106a is opened toward a coupling portion 522 (described later). The coupling portion 106 projects to the opposite side to the end E1 relative to the end wall 104c in the X-axis direction.

On the bottom wall of the coupling portion 106, a communicating hole H6 (see FIGS. 7 and 8), which is communicated with the inside of the main body portion 104, is formed. The communicating hole H6 allows insertion of respective one ends (not illustrated) of the winding wires corresponding to the respective phases (the U-phase, the V-phase, and the W-phase) of the winding wire 14a. These one ends of the winding wires inserted through the communicating hole H6 are drawn to the inside of the coupling portion 106.

On the bottom wall of the coupling portion 106, a terminal unit 400 (see FIGS. 7 and 8) is disposed. The terminal unit 400 includes a pedestal 402 and three busbars (a conductive member) 404U, 404V, and 404W. The busbars 404U, 404V, and 404W are all constituted by metallic plates, and have crank shapes viewed from the direction parallel to the principal surfaces of the busbars 404U, 404V, and 404W. The busbars 404U, 404V, and 404W are mounted on the pedestal 402. The busbars 404U, 404V, and 404W are arranged along the direction perpendicular to both the X-axis direction and the Z-axis direction. Hereinafter, the direction in which the busbars 404U, 404V, and 404W are arranged is referred to as the “Y-axis direction.”

One ends of the busbars 404U, 404V, and 404W are positioned in the vicinity of the communicating hole H6. The respective one ends of the busbars 404U, 404V, and 404W couple to the one ends of the winding wire 14a drawn to the inside of the coupling portion 106. Specifically, the one end of the busbar 404U couples to the one end corresponding to the U-phase in the winding wire 14a. The one end of the busbar 404V couples to the one end corresponding to the V-phase in the winding wire 14a. The one end of the busbar 404W couples to the one end corresponding to the W-phase in the winding wire 14a.

The other ends of the busbars 404U, 404V, and 404W extend in the Z-axis direction toward the inverter housing portion 300 side. Accordingly, the other ends of the busbars 404U, 404V, and 404W are exposed to the outside of the coupling portion 106.

On the bottom wall of the coupling portion 106, as illustrated in FIG. 8, connectors 108 and 110 are disposed. The connectors 108 and 110 are exposed to the outside of the coupling portion 106. The connector 108, the terminal unit 400, and the connector 110 are arranged in this order in the Y-axis direction. That is, the terminal unit 400 is positioned between the connector 108 and the connector 110.

The connector 108 is coupled to a resolver (not illustrated), which detects the rotation angle of the motor 14, by a resolver signal line SG1 (see FIG. 2). The resolver is arranged inside the main body portion 104. Accordingly, the resolver signal line SG1 extends from the coupling portion 106 to the inside of the main body portion 104 through the communicating hole H6. The connector 110 is coupled to the winding-wire switcher 16 by a winding-wire switching signal line SG2 (see FIG. 2).

### [3.2] Winding-Wire Switching/Housing Portion

As illustrated in FIGS. 3 to 8, the winding-wire switching/housing portion 200 is secured to the end on the end wall 104c side of the cylinder body 104a with bolts (see FIGS. 3, 5, and 6). Accordingly, the winding-wire switching/housing portion 200 is integrally combined with the motor housing portion 100 to be removable.

The winding-wire switching/housing portion 200 is arranged on the outer side of the motor housing portion 100 and on the end E2 side of the motor shaft 14d. The winding-wire switching/housing portion 200 overlaps the motor housing portion 100 in the X-axis direction. The winding-wire switching/housing portion 200 has a housing case (a third housing portion) 202 and the winding-wire switcher 16.

The housing case 202 includes a main body portion 204 and a lid portion 206. The main body portion 204 has a bottomed cylindrical shape whose one side is opened. That is, the main body portion 204 includes an opening portion 204a (see FIGS. 7 to 9), which is opened toward the outer side, a bottom wall 204b, which has a flat plate shape, and a side wall 204c, which is disposed extending along the peripheral edge of the bottom wall 204b.

The opening portion 204a is constituted by the end edge on the open end side of the side wall 204c. To the opening portion 204a, the lid portion 206, which closes the opening portion 204a, is secured with bolts (see FIGS. 3, 5, and 6). In the state where the lid portion 206 is mounted on the opening portion 204a, the space surrounded by the main body portion 204 and the lid portion 206 becomes a housing space that houses the winding-wire switcher 16.

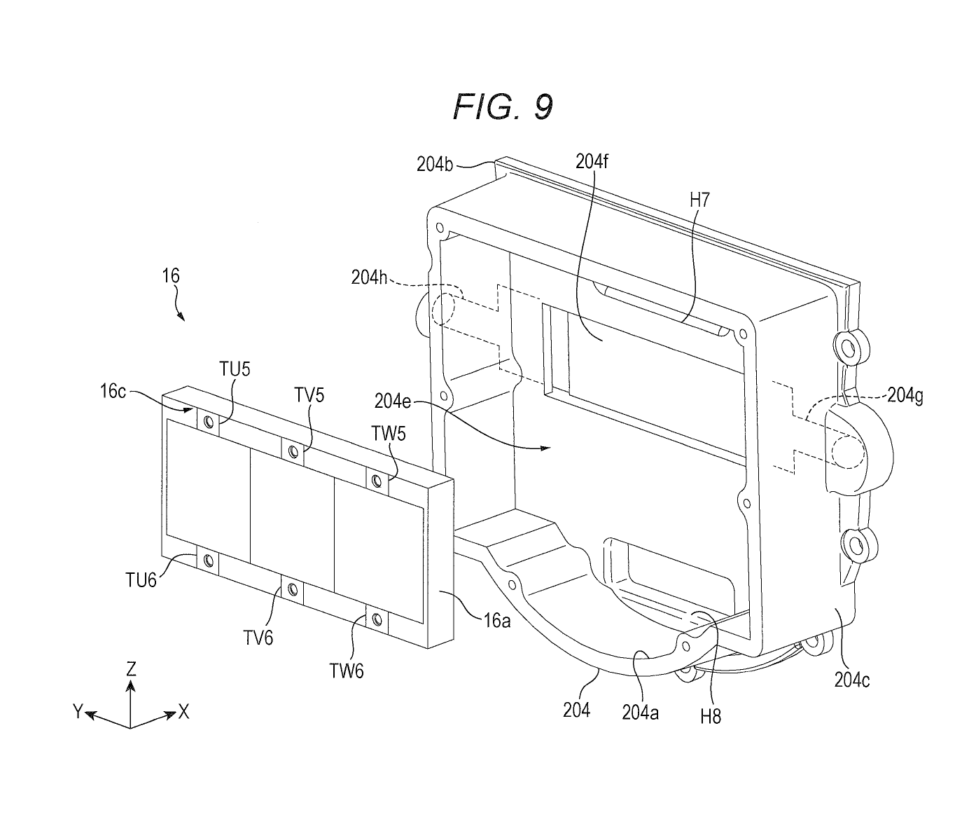

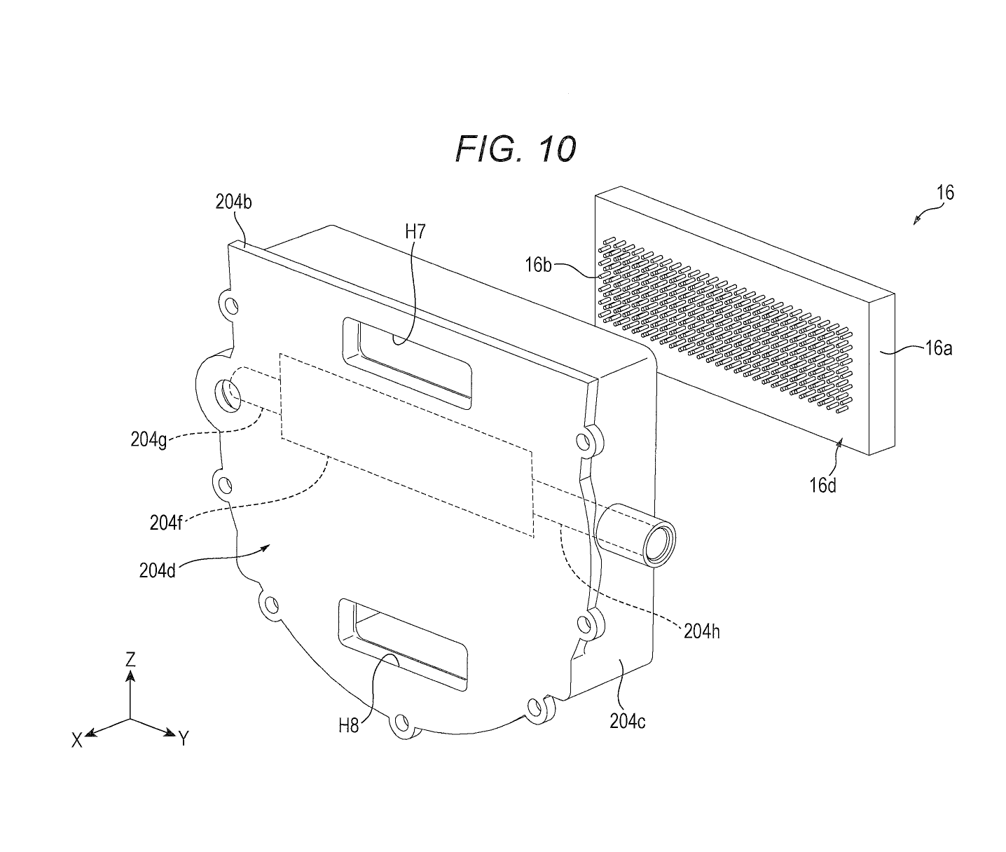

The bottom wall 204b is secured to the end on the end wall 104c side in the cylinder body 104a with bolts (see FIGS. 3, 5, and 6). Accordingly, in the completed state of the driving device 3 as illustrated in FIG. 10, one principal surface 204d of the bottom wall 204b faces the end wall 104c of the motor housing portion 100. On the other principal surface 204e of the bottom wall 204b, as illustrated in FIGS. 7 and 9, a depressed portion 204f is formed. The depressed portion 204f is depressed toward the side apart from the opening portion 204a, that is, the principal surface 204d side. The long side of the depressed portion 204f extends along the Y-axis direction.

As illustrated in FIG. 9, the bottom wall 204b has flow passages 204g and 204h where a cooling liquid circulates. The flow passages 204g and 204h are formed inside the wall of the bottom wall 204b, and extend along the Y-axis direction.

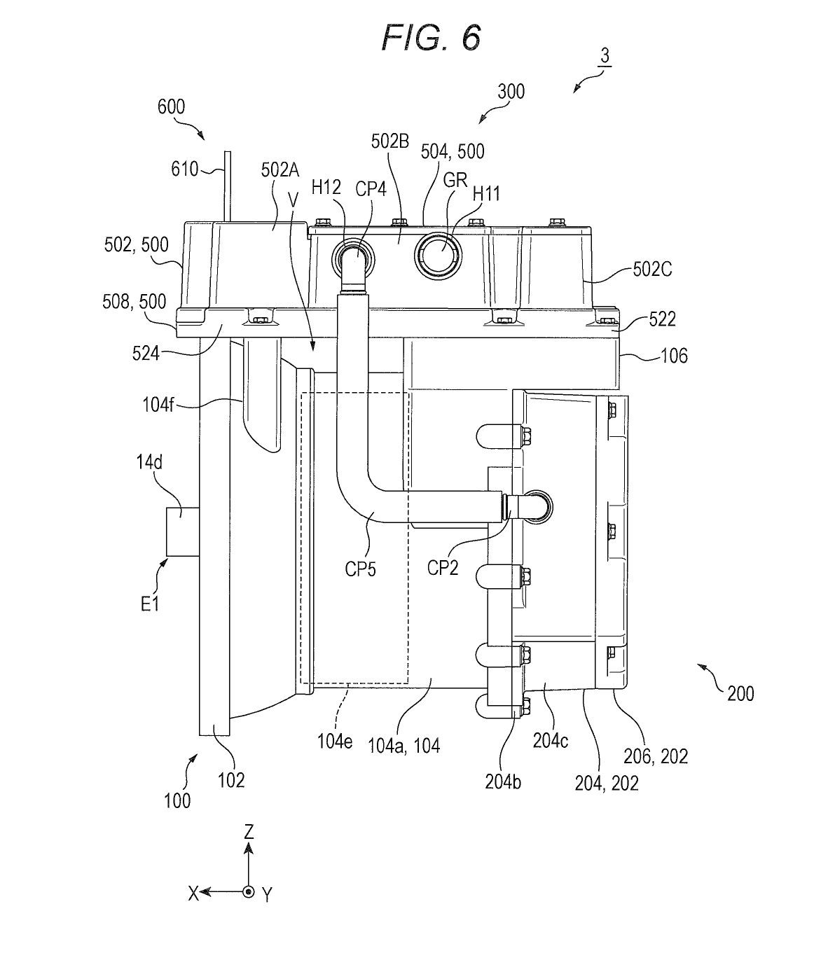

One end of the flow passage 204g is communicated with the region on one end side of the depressed portion 204f in the Y-axis direction. As illustrated in FIGS. 3, 5, and 8, the other end of the flow passage 204g couples to the flow passage 104g in the completed state of the driving device 3. One end of the flow passage 204h is communicated with the region on the other end side of the depressed portion 204f in the Y-axis direction. As illustrated in FIGS. 4 and 6, the other end of the flow passage 204h couples to a cooling pipe CP2 in the completed state of the driving device 3.

On the bottom wall 204b, through-holes H7 and H8 are formed. The through-hole H7, the depressed portion 204f, and the through-hole H8 are arranged in this order in the Z-axis direction. Accordingly, the depressed portion 204f is positioned between the through-hole H7 and the through-hole H8. The through-hole H7 is positioned biased to the inverter housing portion 300 relative to the depressed portion 204f. The through-hole 118 is positioned on the side apart from the inverter housing portion 300 relative to the depressed portion 204f.

In the completed state of the driving device 3, as illustrated in FIG. 7, the through-hole H7 faces and is communicated with the through-hole H4 of the motor housing portion 100. These through-holes H4 and H7 allow insertion of the terminals TU3, TV3, and TW3 (see FIG. 2) drawn from the end E2 side of the motor shaft 14d in the motor 14. The tips of the terminals TU3, TV3, and TW3 are drawn to the inside of the housing case 202.

In the completed state of the driving device 3, as illustrated in FIG. 7, the through-hole H8 faces and is communicated with the through-hole H5 of the motor housing portion 100. These through-holes H5 and H8 allow insertion of the te minals TU4, TV4, and TW4 (see FIG. 2) drawn from the end E2 side of the motor shaft 14d in the motor 14. The tips of the terminals TU4, TV4, and TW4 are drawn to the inside of the housing case 202.

As illustrated in FIGS. 8 and 9, the winding-wire switcher 16 is secured to the bottom wall 204b with bolts (not illustrated). As illustrated in FIG. 10, the winding-wire switcher 16 includes a flat plate-shaped circuit main body portion 16a and fins 16b. In this embodiment, the circuit main body portion 16a and the fins 16b are integrated. However, these need not be integrated. Alternatively, in the winding-wire switcher 16, the circuit main body portion 16a may be integrally coupled to (modularized with) the heat sink having the fins 16b. That is, the water cooling system for the circuit main body portion 16a (the winding-wire switcher 16) may be a direct water cooling system or an indirect water cooling system.

The circuit main body portion 16a incorporates the above-described winding-wire switching circuit. The circuit main body portion 16a is coupled to the connector 110 by the winding-wire switching signal line SG2. On one principal surface 16c of the circuit main body portion 16a, as illustrated in FIG. 9, three terminals TU5, TV5, and TW5 and three terminals TU6, TV6, and TW6 are arranged along the Y-axis direction.

The terminals TU5, TV5, and TW5 are positioned biased to the inverter housing portion 300 on the peripheral edge of the circuit main body portion 16a. The terminals TU5, TV5, and TW5 are electrically and physically coupled to the respective tips of the terminals TU3, TV3, and TW3 with bolts (not illustrated). The terminals TU6, TV6, and TW6 are positioned on the side apart from the inverter housing portion 300 on the peripheral edge of the circuit main body portion 16a. The terminals TU6, TV6, and TW6 are electrically and physically coupled to the respective tips of the terminals TU4, TV4, and TW4 with bolts (not illustrated).

As illustrated in FIG. 9, the other principal surface 16d of the circuit main body portion 16a faces the depressed portion 204f and covers the depressed portion 204f. Accordingly, the space surrounded by the circuit main body portion 16a and the depressed portion 204f constitutes a flow passage (a third cooler) 16g (see FIG. 7) where a cooling liquid circulates.

The flow passage 16g extends in the direction (the Y-axis direction) identical to the extending direction of the depressed portion 204f. One end of the flow passage 16g couples to the flow passage 204g. The other end of the flow passage 16g couples to the flow passage 204h. The flow passage 16g is positioned between the circuit main body portion 16a and the motor housing portion 100.

The fins 16b project outward from the other principal surface 16d of the circuit main body portion 16a (see FIGS. 7 and 10). In the state where the winding-wire switcher 16 is mounted on the bottom wall 204b, the fins 16b are positioned inside the flow passage 16g. Flowing of the cooling liquid into the flow passage 16g causes contact of the cooling liquid with the fins 16b positioned inside the flow passage 16g. This promotes the heat diffusion from the fins 16b (the circuit main body portion 16a). That is, the fins 16b function as the member for diffusing the heat of the circuit main body portion 16a to the outside.

### [3.3] Inverter Housing Portion

As illustrated in FIGS. 3 to 8, the inverter housing portion 300 is mounted on the motor housing portion 100. The inverter housing portion 300 is supported by the coupling portion 106 of the motor housing portion 100 and the plurality of support pillars 104f. The inverter housing portion 300 has a housing case (a second housing portion) 500, the controller 18, a capacitor unit 600, the inverter unit 10, and a terminal unit 700.

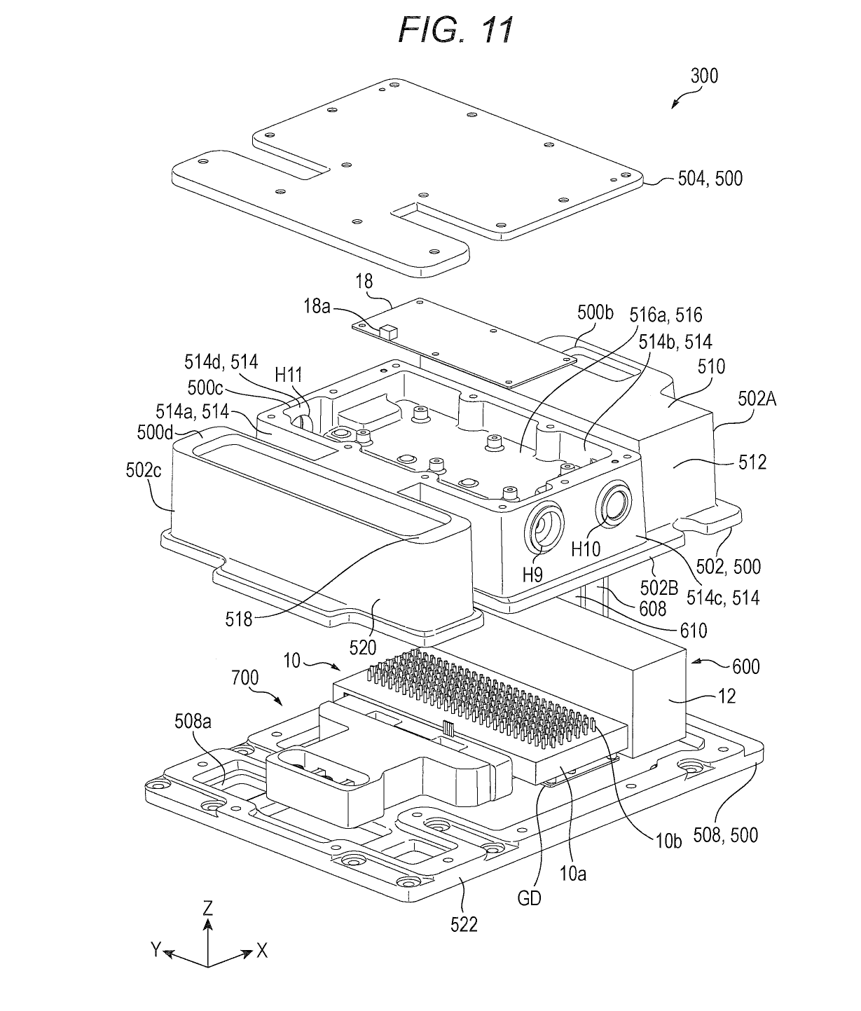

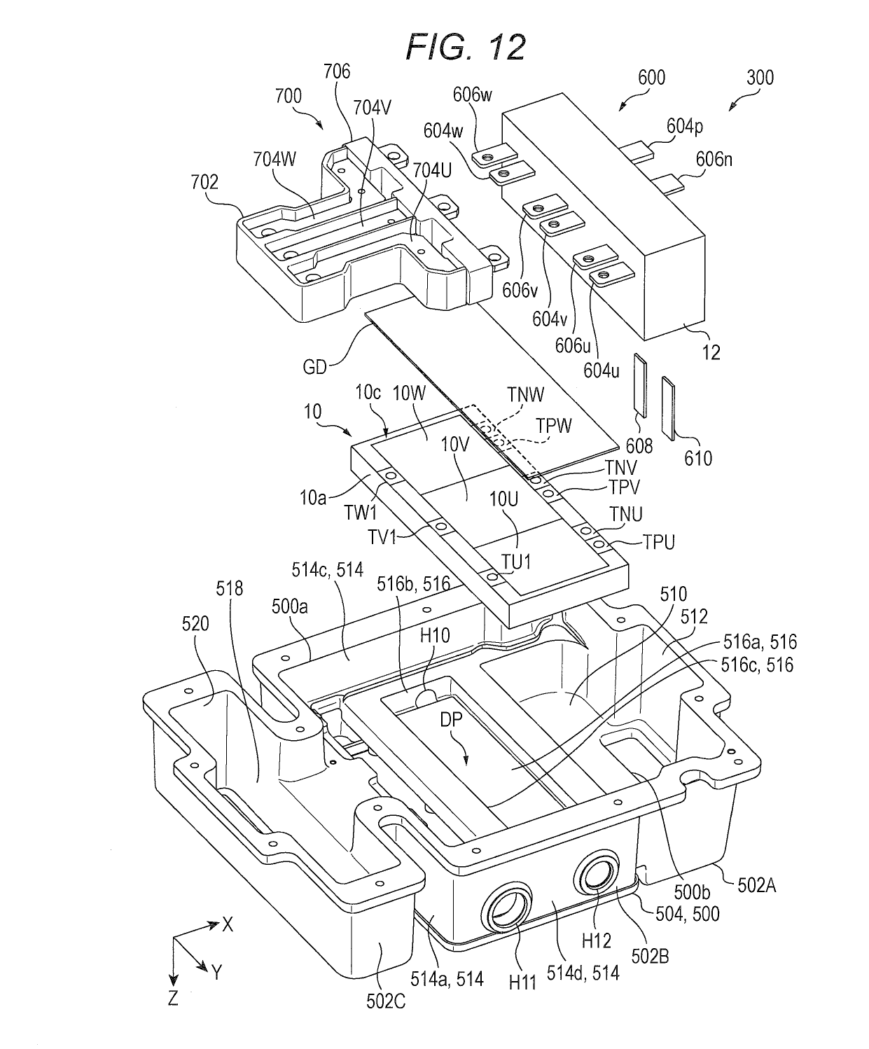

As illustrated in FIGS. 11 and 12, in the completed state of the driving device 3, the housing case 500 includes an opening portion (a housing port) 500a, which is opened toward the motor housing portion 100 side, and opening portions 500b to 500d, which are opened toward the opposite side to the motor housing portion 100. As illustrated in FIG. 11, the housing case 500 includes a main body portion 502 and lid portions 504 and 508. The main body portion 502 includes first to third portions 502A to 502C. The first to third portions 502A to 502C are arranged in this order in the X-axis direction, and are integrated.

As illustrated in FIG. 4, in the completed state of the driving device 3, the first portion 502A is positioned on the end E1 side of the motor shaft 14d and over the end E1. As illustrated in FIGS. 11 and 12, the first portion 502A has a depressed portion that is depressed toward the side apart from the motor housing portion 100. That is, the first portion 502A includes a bottom wall 510 and a side wall 512. The side wall 512 is disposed on the bottom wall 510 to project from the bottom wall 510 toward the motor housing portion 100 side. On the bottom wall 510, the opening portion 500b is formed. The end edge (the open end of the first portion 502A) of the side wall 512 constitutes a part of the opening portion 500a.

The second portion 502B is positioned between the first portion 502A and the third portion 502C in the X-axis direction and over the cylinder body 104a. The second portion 502B includes a side wall 514 and an intermediate wall 516, which is arranged on the inner side of the side wall 514. The end edge on the side apart from the motor housing portion 100 in the side wall 514 constitutes the opening portion 500c. The end edge biased to the motor housing portion 100 in the side wall 514 constitutes a part of the opening portion 500a.

The side wall 514 includes a pair of wall portions 514a and 514b, which face each other in the X-axis direction, and a pair of wall portions 514c and 514d, which face each other in the Y-axis direction. The wall portions 514a and 514b are both adjacent to the wall portions 514c and 514d. The intermediate wall 516 extends along the Y-axis direction to expand in the direction perpendicular to the Z-axis direction. The intermediate wall 516 couples to the wall portions 514b to 514d. However, the intermediate wall 516 does not couple to the wall portion 514a.

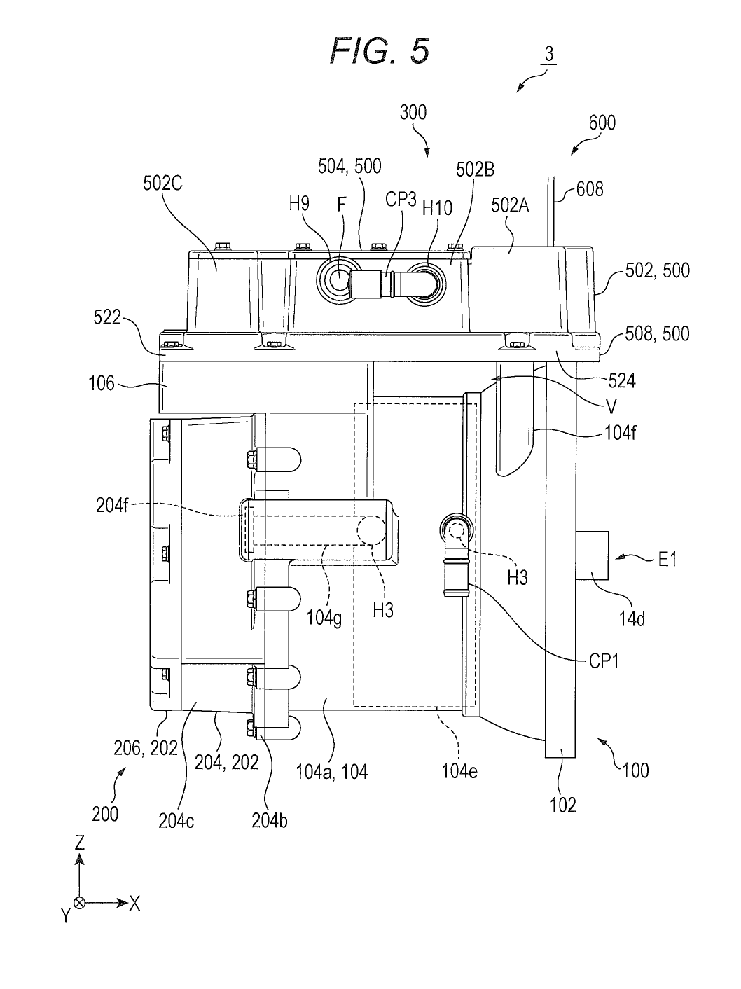

In the wall portion 514c, as illustrated in FIGS. 3 and 11, through-holes H9 and H10 passing through the inside and outside of the second portion 502B are formed. The through-hole H9 is positioned biased to the wall portion 514a in the wall portion 514c. In the through-hole H9, a waterproof breathable filter F is mounted (see FIGS. 3 and 5). The waterproof breathable filter F allows passage of gas (such as air) while not allowing passage of liquid (such as water). The through-hole H10 is positioned biased to the wall portion 514b in the wall portion 514c. The through-hole H10 couples to a cooling pipe CP3 (see FIGS. 3 and 5). In the state where the driving device 3 is mounted on the electric vehicle EV, the cooling pipe CP3 is couples to, for example, the radiator of the electric vehicle EV.

In the wall portion 514d, as illustrated in FIGS. 4 and 12, through-holes H11 and H12 passing through the inside and outside of the second portion 502B are formed. The through-hole H11 is positioned biased to the wall portion 514a in the wall portion 514d. In the through-hole H11, a wiring outlet/inlet GR is mounted (see FIGS. 4 and 6). The through-hole H12 is positioned biased to the wall portion 514b in the wall portion 514d. The through-hole H12 couples to a cooling pipe CP4 (see FIGS. 4 and 6). The cooling pipe CP4 is coupled to the cooling pipe CP2 of the winding-wire switching/housing portion 200 by a cooling pipe CP5.

The intermediate wall 516 has a depressed portion DP, which is depressed toward the side apart from the motor housing portion 100. That is, as illustrated in FIGS. 11 and 12, the intermediate wall 516 has a bottom wall 516a, a side wall 516b, and an opening portion 516c. The side wall 516b is disposed on the bottom wall 516a to project from the bottom wall 516a toward the motor housing portion 100 side. The opening portion 516c is opened toward the motor housing portion 100 side. The opening portion 516c is constituted by the end edge on the motor housing portion 100 side in the side wall 516b. The depressed portion DP of the intermediate wall 516 extends along the Y-axis direction between the wall portion 514c and the wall portion 514d. The inside of the depressed portion DP of the intermediate wall 516 is communicated with the through-holes H10 and H12 (see FIG. 12).

As illustrated in FIG. 4, in the completed state of the driving device 3, the third portion 502C is positioned on the end E2 side of the motor shaft 14d and over the coupling portion 106. As illustrated in FIGS. 11 and 12, the third portion 502C has a depressed portion that is depressed toward the side apart from the motor housing portion 100. That is, the third portion 502C has a bottom wall 518 and a side wall 520. The side wall 520 is disposed on the bottom wall 518 to project from the bottom wall 518 toward the motor housing portion 100 side. On the bottom wall 518, the opening portion 500d is formed. The end edge (the open end of the third portion 502C) of the side wall 520 constitutes a part of the opening portion 500a.

As illustrated in FIG. 11, the lid portion 504 is secured to the opening portions 500c and 500d with bolts (see FIGS. 3 to 6) to close the opening portions 500c and 500d. The lid portion (a cover portion) 508 is secured to the opening portion 500a with bolts (not illustrated) to close the opening portion 500a. Accordingly, the lid portions 504 and 508 are integrally combined with the main body portion 502 to be removable. The space surrounded by the main body portion 502, the lid portion 504, and the lid portion 508 becomes a housing space (the internal space of the housing case 500) that houses the controller 18, the capacitor unit 600, the inverter unit 10, and the terminal unit 700. That is, the housing case 500 internally houses the inverter unit 10.

As illustrated in FIG. 11, the region on the end E2 side of the motor shaft 14d in the lid portion 508 includes the coupling portion (a second coupling portion) 522. In the completed state of the driving device 3, the coupling portion 522 is secured to the coupling portion 106 with bolts (see FIGS. 3 to 6). In the coupling portion 522, an opening portion (a second opening portion) 508a is formed. The opening portion 508a faces the opening portion 500d in the Z-axis direction. The opening portion 508a is positioned on the end E2 side of the motor shaft 14d relative to a flow passage 10h described later.

In the completed state of the driving device 3, the opening portion 508a corresponds to the opening portion 106a. That is, the opening portion 508a is opened toward the coupling portion 106. Specifically, as illustrated in FIG. 7, the opening portion 508a is positioned overlapping the opening portion 106a and faces the opening portion 106a in the Z-axis direction. That is, the opening portion 106a and the opening portion 508a correspond to each other to communicate between the housing case 102 and the housing case 500 in the state where the housing case 102 and the housing case 500 are integrally combined. Accordingly, the other ends of the busbars 404U, 404V, and 404W and the connectors 108 and 110, which are exposed to the outer side of the coupling portion 106, are positioned inside the housing case 500 (the third portion 502C) while passing through the opening portion 508a.

In the lid portion 508, a portion (the portion on the end E1 side of the motor shaft 14d relative to the coupling portion 522 in the lid portion 508) 524 other than the coupling portion 522 is secured to the support pillars 104f with bolts (see FIGS. 3 to 6).

The portion 524 overlaps the housing case 102 in the Z-axis direction. The portion 524 is separated from the housing case 102 by the presence of the support pillars 104f. Accordingly, as illustrated in FIGS. 5 to 7, a space V is present between the portion 524 and the housing case 102 in the Z-axis direction.

The controller 18 incorporates the above-described control circuit. As illustrated in FIG. 11, the controller 18 is arranged on the principal surface on the lid portion 504 side in the bottom wall 516a. That is, the controller 18 does not overlap the opening portion 508a in the Z-axis direction. The controller 18 is arranged to avoid overlapping the opening portion 508a in the Z-axis direction. On the principal surface of the controller 18, a signal input/output unit 18a is disposed. The signal input/output unit 18a is a member that mediates transmission and reception of the signal between the outside and the control circuit. The signal input/output unit 18a is positioned biased to the wall portion 514a on the principal surface of the controller 18, that is, biased to the end E2 of the motor shaft 14d in the X-axis direction.

The signal input/output unit 18a couples to the signal line SG3 (see FIG. 2). Accordingly, the controller 18 couples to the VCU 1 via the signal input/output unit 18a and the signal line SG3. The signal line SG3 extends to the inside and outside of the housing case 500 through the wiring outlet/inlet GR mounted on the through-hole H11.

The controller 18 is electrically coupled to the resolver of the motor 14 by the resolver signal line SG1 via the connector 108. The resolver signal line SG1 extends from the controller 18 toward the opening portion 508a in the housing case 500. The controller 18 receives a resolver signal from the resolver.

The controller 18 is electrically coupled to the winding-wire switcher 16 (the circuit main body portion 16a) by the winding-wire switching signal line SG2 via the connector 110. The winding-wire switching signal line SG2 extends from the controller 18 toward the opening portion 508a in the housing case 500. The controller 18 transmits a winding-wire switching signal to the winding-wire switcher 16 (the circuit main body portion 16a).

As illustrated in FIGS. 11 and 12, the capacitor unit 600 is housed inside the first portion 502A. The capacitor unit 600 includes the capacitor 12, busbars (an input unit) 604p and 606n, busbars 604u, 604v, 604w, 606u, 606v, and 606w, and busbars (a power-supply coupling portion) 608 and 610. These busbars are constituted by metallic plates.

The busbars 604p, 604u, 604v, and 604w couple to the positive electrode of the capacitor 12. The busbars 606n, 606u, 606v, and 606w couple to the negative electrode of the capacitor 12.

The busbars 604p and 606n are arranged in this order in the Y-axis direction. The busbars 604u, 604v, and 604w are arranged in this order in the Y-axis direction. The busbars 606u, 606v, and 606w are arranged in this order in the Y-axis direction.

The base end (the other end) of the busbar 608 couples to the tip of the busbar 604p. Accordingly, the busbars 606, the busbar 608, and the positive electrode of the capacitor 12 are electrically coupled together. The busbar 608 functions as the terminals TP1 and TP2 (see FIG. 2).

The base end (the other end) of the busbar 610 couples to the tip of the busbar 606n. Accordingly, the busbars 606, the busbar 610, and the negative electrode of the capacitor 12 are electrically coupled together. The busbar 610 functions as the terminals TN1 and TN2 (see FIG. 2).

In the completed state of the driving device 3, as illustrated in FIGS. 3 to 7, the tips (one ends) of the busbars 608 and 610 are exposed to the outside of the housing case 500 through the opening portion 500b. The externally exposed tips of the busbars 608 and 610 electrically couple to the battery 2. The battery 2 is, for example, mounted on the lid portion 504 of the housing case 500.

As illustrated in FIGS. 11 and 12, the inverter unit 10 is housed inside the second portion 502B. As illustrated in FIG. 12, the inverter unit 10 is secured to the motor housing portion 100 side in the intermediate wall 516 with bolts (not illustrated). The inverter unit 10 does not overlap the opening portion 508a in the Z-axis direction. That is, the inverter unit 10 is arranged to avoid overlapping the opening portion 508a in the Z-axis direction. The inverter unit 10 includes a power module including a semiconductor. This power module includes, for example, a circuit main body portion 10a and fins 10b. In this embodiment, the circuit main body portion 10a and the fins 10b are integrated. However, these need not be integrated. Alternatively, in the inverter unit 10, the circuit main body portion 10a may be integrally coupled to (modularized with) the heat sink having the fins 10b. That is, the water cooling system for the circuit main body portion 10a (the power module) may be a direct water cooling system or an indirect water cooling system.

The circuit main body portion 10a incorporates the above-described power converter circuit. The circuit main body portion 10a includes a U-phase portion (a first phase portion) 10U, a V-phase portion (a second phase portion) 10V, and a W-phase portion (a third phase portion) 10W. The U-phase portion 10U converts the DC power input from the battery 2 into the AC power output to the U-phase of the motor 14. The V-phase portion 10V converts the DC power input from the battery 2 into the AC power output to the V-phase of the motor 14. The W-phase portion 10W converts the DC power input from the battery 2 into the AC power output to the W-phase of the motor 14. The U-phase portion 10U, the V-phase portion 10V, and the W-phase portion 10W are arranged in this order in the Y-axis direction.

On the one principal surface 10d of the circuit main body portion 10a, six terminals TPU, TNU, TPV, TNV, TPW, and TNW are arranged in this order along the Y-axis direction. The terminals TPU, TNU, TPV, TNV, TPW, and TNW are positioned biased to the capacitor unit 600 on the peripheral edge of the circuit main body portion 10a.

The terminals TPU and TNU are adjacent to the U-phase portion 10U in the X-axis direction, and electrically couple to the U-phase portion 10U. The terminal TPU and the terminal TNU are adjacent to each other in the Y-axis direction. The terminal TPU is physically and electrically coupled to the busbar 604u of the busbars 604 with a bolt (not illustrated). The terminal TNU is physically and electrically coupled to the busbar 606u of the busbars 606 with a bolt (not illustrated).

The terminals TPV and TNV are adjacent to the V-phase portion 10V in the X-axis direction, and electrically couple to the V-phase portion 10V. The terminal TPV and the terminal TNV are adjacent to each other in the Y-axis direction. The terminal TPV is physically and electrically coupled to the busbar 604v of the busbars 604 with a bolt (not illustrated). The terminal TNV is physically and electrically coupled to the busbar 606v of the busbars 606 with a bolt (not illustrated).

The terminals TPW and TNW are adjacent to the W-phase portion 10W in the X-axis direction, and electrically couple to the W-phase portion 10W. The terminal TPW and the terminal TNW are adjacent to each other in the Y-axis direction. The terminal TPW is physically and electrically coupled to the busbar 604w of the busbars 604 with a bolt (not illustrated). The terminal TNW is physically and electrically coupled to the busbar 606w of the busbars 606 with a bolt (not illustrated).

On one principal surface 10c (see FIGS. 7 and 12) of the circuit main body portion 10a, the three terminals TU1, TV1, and TW1 are arranged in this order along the Y-axis direction. The terminals TU1, TV1; and TW1 are positioned biased to the terminal unit 700 on the peripheral edge of the circuit main body portion 10a.

The terminal TU1 is adjacent to the U-phase portion 10U in the X-axis direction, and electrically couples to the U-phase portion 10U. The terminal TV1 is adjacent to the V-phase portion 10V in the X-axis direction, and electrically couples to the V-phase portion 10V. The terminal TW1 is adjacent to the W-phase portion 10W in the X-axis direction, and electrically couples to the W-phase portion 10W.

As illustrated in FIGS. 7 and 12, the other principal surface 10d of the circuit main body portion 10a faces the depressed portion DP and covers the depressed portion DP (the opening portion 516c). Accordingly, the space surrounded by the circuit main body portion 10a and the depressed portion DP constitutes a flow passage (a second cooler) 10h (see FIG. 7) where a cooling liquid circulates. This space is arranged inside the housing case 500. Accordingly, the housing case 500 includes the flow passage 10h.

The flow passage 10h extends in the direction (the Y-axis direction) identical to the extending direction of the depressed portion DP. Accordingly, the extending direction of the flow passage 10h is approximately identical to the arrangement direction of the U-phase portion 10U, the V-phase portion 10V, and the W-phase portion 10W. Both ends of the flow passage 10h couple to the respective through-holes H10 and H12. The flow passage 10h is positioned between the circuit main body portion 10a and the controller 18. In this embodiment, as illustrated in FIG. 7, the motor 14, the flow passage 104e, the space V, the circuit main body portion 10a, the flow passage 10h, and the controller 18 are arranged in this order along the Z-axis direction.

As illustrated in FIG. 11, the fins 10b project outward from the other principal surface 10d of the circuit main body portion 10a. In the state where the inverter unit 10 is mounted on the intermediate wall 516, the fins 10b are positioned inside the flow passage 10h. Flowing of the cooling liquid into the flow passage 10h causes contact of the cooling liquid with the fins 10b positioned inside the flow passage 10h. This promotes the heat diffusion from the fins 10b (the circuit main body portion 10a). That is, the fins 10b function as the member for diffusing the heat of the circuit main body portion 10a to the outside.

In this embodiment, a gate drive circuit GD is disposed close to the inverter unit 10. For example, as illustrated in FIG. 12, the gate drive circuit GD is mounted on the principal surface 10e side of the circuit main body portion 10a. The gate drive circuit GD is electrically coupled to the controller 18 inside the housing case 500 by a signal line SG4 (see FIG. 2). The gate drive circuit GD receives the inverter control signal from the controller 18 via the signal line SG4. Based on this inverter control signal, the gate drive circuit GD generates a gate signal for turning on/off the switch elements Q1 to Q6 included in the power converter circuit of the circuit main body portion 10a.

The gate drive circuit GD is mounted on the circuit main body portion 10a on the principal surface 10c side of the circuit main body portion 10a. The gate drive circuit GD electrically couples to the circuit main body portion 10a. The gate signal generated by the gate drive circuit GD is transmitted to the circuit main body portion 10a.

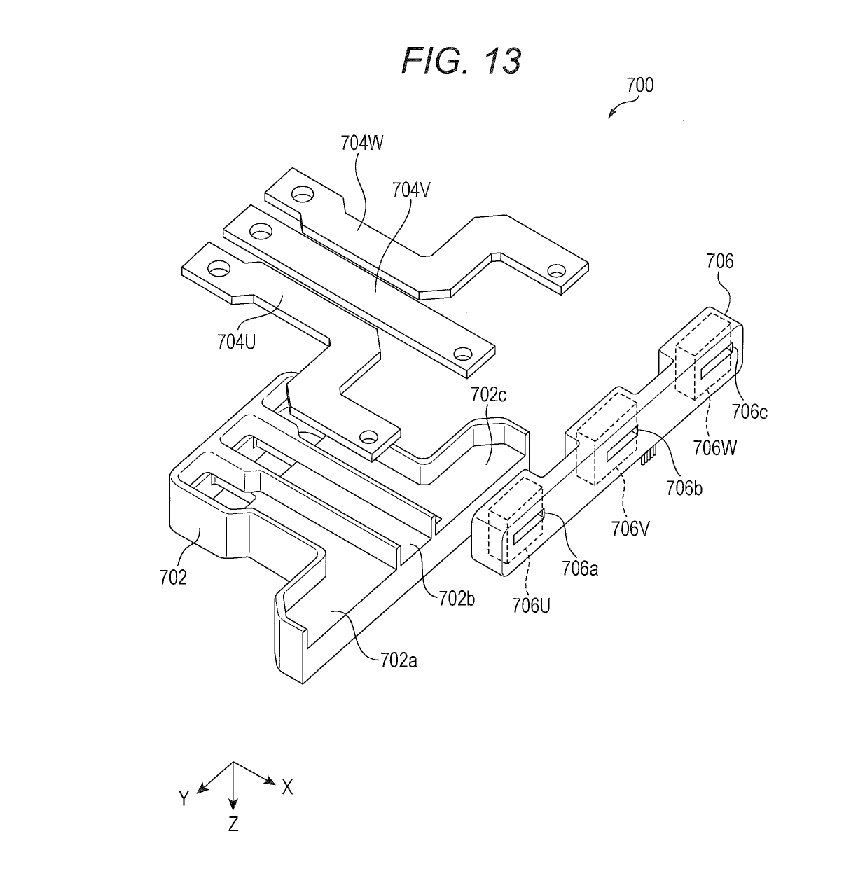

As illustrated in FIGS. 12 and 13, the terminal unit 700 includes a pedestal 702, three busbars (the conductive member) 704U, 704V, and 704W, and a sensor unit 706. As illustrated in FIG. 13, the pedestal 702 includes groove portions 702a to 702c corresponding to the respective shapes of the busbars 704U, 704V, and 704W. The groove portions 702a to 702c are arranged in this order in the Y-axis direction.

The busbars 704U and 704W are both constituted in crank shape viewed from the direction perpendicular to the principal surfaces of the busbars 704U and 704W. The busbars 704U, 704V, and 704W are each mounted on the pedestal 702 in the state housed in the groove portions 702a to 702c. Accordingly, the busbars 704U, 704V, and 704W are arranged in this order in the Y-axis direction.

As illustrated in FIG. 12, one ends of the busbars 704U, 704V, and 704W are physically and electrically coupled to the respective terminals TU1, TV1, and TW1 of the circuit main body portion 10a with bolts. The other ends of the busbars 704U, 704V, and 704W are physically and electrically coupled to the respective other ends of the busbars 404U, 404V, and 404W with bolts. Accordingly, the busbars 404U and 704U constitute the lead wire between the terminal TU1 and the terminal TU2 illustrated in FIG. 2. The busbars 404V and 704V constitute the lead wire between the terminal TV1 and the terminal TV2 illustrated in FIG. 2. The busbars 404W and 704W constitute the lead wire between the terminal TW1 and the terminal TW2 illustrated in FIG. 2.

As illustrated in FIG. 13, the sensor unit 706 has a rectangular parallelepiped shape. In the sensor unit 706, through-holes 706a to 706c passing through the sensor unit 70 in the X-axis direction are formed. The through-holes 706a to 706c are arranged in this order in the Y-axis direction. Into the through-holes 706a to 706c, the respective one ends of the busbars 704U, 704V, and 704W are inserted.

Inside the sensor unit 706 and in the vicinity of the through-hole 706a, an electric-current measurer 706U is arranged. Inside the sensor unit 706 and in the vicinity of the through-hole 706b, an electric-current measurer 706V is arranged. Inside the sensor unit 706 and in the vicinity of the through-hole 706c, an electric-current measurer 706W is arranged. The electric-current measurers 706U, 706V and 706W are non-contact sensors. The electric-current measurers 706U, 706V and 706W measure the respective electric currents flowing through the busbars 704U, 704V, and 704W, which are inserted into the through-holes 706a to 706c. The signals measured by the electric-current measurers 706U, 706V and 706W are input to the controller 18 inside the housing case 500 via signal lines (not illustrated).

[4] Operation of Winding-Wire Switcher

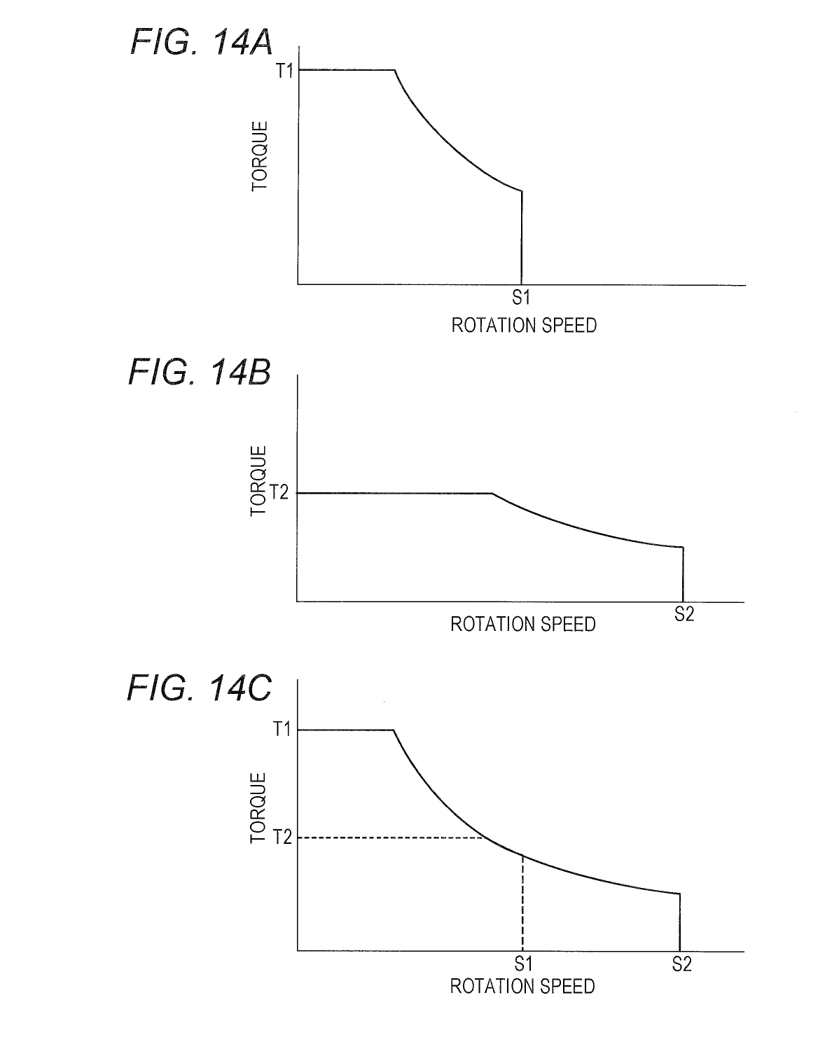

In the low-speed driving state of the motor 14, as illustrated in FIG. 14A, a maximum torque T1 is relatively large while a highest rotation speed S1 is relatively small. On the other hand, in the high-speed driving state of the motor 14, as illustrated in FIG. 14B, a maximum torque T2 is relatively small while a highest rotation speed S2 is relatively large. Switching between the low-speed driving state and the high-speed driving state of the motor 14 by the winding-wire switcher 16 allows realizing a plurality of driving states using one motor 14. Accordingly, as illustrated in FIG. 14C, in the constant torque region of the motor 14, the motor 14 can generate the maximum torque T1 having a large magnitude. Furthermore, in the constant output region of the motor 14, the motor 14 can be rotated at the highest rotation speed S2 having a larger magnitude.

### [5] Actions

In the above-described embodiment, the cooling water cooled in the radiator of the electric vehicle EV flows through the cooling pipe CP3, the through-hole H10, the flow passage 10h (a plate-like portion 1 Oe and the depressed portion DP), the through-hole H12, the cooling pipe CP4, the cooling pipe CP5, the cooling pipe CP2, the flow passage 204h, the flow passage 16g (a plate-like portion 16e and the depressed portion 204f), the flow passage 204g, the flow passage 104g, the through-hole H3, the flow passage 104e, the through-hole H2, and the cooling pipe CP1 in this order and returns to the radiator again. Accordingly, in this embodiment, the inverter unit 10, the winding-wire switcher 16, and the motor 14 are cooled in this order. The order in which the cooling water flows may be the reverse order of the above-described order. At this time, the motor 14, the winding-wire switcher 16, and the inverter unit 10 are cooled in this order. The order in which the inverter unit 10, the winding-wire switcher 16, and the motor 14 are cooled is not specifically limited, but may be any order. In the above-described embodiment, the flow passage 16g is arranged between the flow passage 10h and the flow passage 104e in a refrigerant flow passage.

In this embodiment, the flow passage 104e is positioned between the motor 14 and the inverter unit 10. Accordingly, the respective heats generated in the motor 14 and the inverter unit 10 are both absorbed by the cooling liquid flowing through the flow passage 104e, thus being less likely to affect each other. This allows reducing the influence of heat on the inverter unit 10 and the motor 14. Additionally, in this embodiment, the inverter unit 10 is positioned between the flow passage 10h and the flow passage 104e. Accordingly, the heat generated in the inverter unit 10 is absorbed by the cooling liquid flowing through the flow passage 104e and the flow passage 10h, thus being less likely to be released to the outside of the driving device 3. This allows reducing the influence of heat also on the outside of the driving device 3.

In this embodiment, the flow passage 10h is positioned between the inverter unit 10 and the controller 18. Accordingly, the heat generated in the inverter unit 10 is less likely to act on the controller 18. This allows reducing the influence of the heat in the inverter unit 10 on the controller 18. When the controller 18 cannot accurately perform the control due to the influence of heat, it becomes difficult to provide the function of the driving device 3. The driving device 3 according to this embodiment can reduce such possibility, and thus it is effective in particular. Additionally, the reduction of the influence of the heat in the inverter unit 10 on the controller 18 allows shortening the separation distance between the inverter unit 10 and the controller 18. This allows downsizing the driving device 3.

In this embodiment, the housing case 102 of the motor housing portion 100 and the housing case 500 of the inverter housing portion 300 are integrally combined through the coupling portion 106 and the coupling portion 522. Furthermore, the motor housing portion 100 and the inverter housing portion 300 are arranged in the Z-axis direction. Accordingly, the driving device 3 is mounted on the electric vehicle EV such that the motor 14 as a heavy load is positioned on the lower side, so as to allow the motor housing portion 100 to support the inverter housing portion 300 and the battery 2 also in the case where the battery 2 is further arranged on the inverter housing portion 300. In this case, the battery 2 is adjacent to the inverter housing portion 300. This allows facilitating the electrical connection between the battery 2 and the inverter unit 10.

The motor housing portion 100 and the inverter housing portion 300 need not be integrally combined. Furthermore, between these, a signal line and a conductive member may be disposed so as to electrically couple the motor 14 and the inverter unit 10 together. In this case, typically, a space for extending these signal line and conductive member between the motor housing portion 100 and the inverter housing portion 300 is disposed. However, in this embodiment, the housing case 102 of the motor housing portion 100 and the housing case 500 of the inverter housing portion 300 are integrally combined through the coupling portion 106 and the coupling portion 522. Furthermore, the signal lines SG1 and SG2 and the busbars 404U, 404V, and 404W extend between the housing case 102 and a housing case 602 through the opening portion 106a of the coupling portion 106 and the opening portion 508a of the coupling portion 522. Accordingly, this embodiment does not require the space for extending the signal line and the conductive member between the motor housing portion 100 and the inverter housing portion 300. Therefore, it is possible to reduce the installation space of the driving device 3 in the electric vehicle EV to mount the driving device 3 inside the electric vehicle EV.

In the case where a load couples to the end E1 side of the motor shaft 14d, the wiring of the motor 14 is typically drawn from the end E2 side of the motor shaft 14d. Therefore, in this embodiment, on the end E2 side of the motor shaft 14d, the housing case 102 of the motor housing portion 100 and the housing case 500 of the inverter housing portion 300 are integrally combined through the coupling portion 106 and the coupling portion 522. In this case, the wiring drawn from the motor 14 is positioned in the vicinity of the coupling portions 106 and 522. This allows shortening and simplifying the wiring of the motor.

In this embodiment, the portion 524 and the housing case 102 are separated by the presence of the support pillars 104f. Accordingly, in the Z-axis direction, the space V is caused between the motor housing portion 100 and the inverter housing portion 300. Therefore, the interposition of an air layer between the motor housing portion 100 and the inverter housing portion 300 makes it difficult to transfer heat between the motor 14 and the inverter unit 10. This allows further reducing the influence of heat on the motor 14 and the inverter unit 10.

In the direction (the Z-axis direction) perpendicular to the motor shaft 14d, in particular, the space V is formed in at least a part of a portion where the inverter unit 10 and the winding wire of the motor 14 are put one over another (overlap). This can improve the effect of suppressing the adverse effect of heat generated from the winding wire of the motor 14, to the inverter unit 10 and the controller 18. Moreover, the winding wire of the motor 14 is covered with the housing case 102. Thus, when the inverter housing portion 300 is removed from the motor housing portion 100 for maintenance or the like, entry of foreign matter into the winding wire can be prevented or suppressed. As a result, the occurrence of the failure can be suppressed.

In this embodiment, the flow passage 16g is arranged between the motor housing portion 100 and the winding-wire switcher 16. Accordingly, the respective heats generated in the motor 14 and the winding-wire switcher 16 are less likely to affect each other. This allows reducing the influence of heat on the motor 14 and the winding-wire switcher 16.

In this embodiment, in the X-axis direction, the capacitor unit 600, the inverter unit 10, and the terminal unit 700 are arranged in this order from the end E1 side toward the end E2 side of the motor shaft 14d. More specifically, in the X-axis direction, the busbars 608 and 610, the busbars 604p and 606n, the capacitor 12, the inverter unit 10, and the busbars 704U, 704V, and 704W are arranged in this order from the end E1 side toward the end E2 side of the motor shaft 14d and electrically coupled to one another in this order. This allows shortening the conductive path between the respective elements inside the inverter housing portion 300.

In the case where a load couples to the end E1 side of the motor shaft 14d, the wiring of the motor 14 is typically drawn from the end E2 side of the motor shaft 14d. Therefore, in this embodiment, on the end E2 side of the motor shaft 14d, the inverter unit 10 and the motor 14 are electrically coupled to each other. In this case, the wiring drawn from the motor 14 is positioned biased to the inverter unit 10. This shortens the wiring of the motor 14 extending from the motor 14 toward the inverter unit 10, that is, the conductive path between the motor 14 and the inverter unit 10. Thus, the entire conductive path of the driving device 3 becomes short. This reduces the electrical resistance of the conductive path of the driving device 3. This consequently allows reducing the loss of electric energy, thus more efficiently supplying electricity to the motor 14.

In this embodiment, the U-phase portion 10U, the V-phase portion 10V, and the W-phase portion lOW of the inverter unit 10 are arranged along the Y-axis direction. That is, the Y-axis direction in which the U-phase portion 10U, the V-phase portion 10V, and the W-phase portion 10W are arranged is perpendicular to the X-axis direction in which the capacitor unit 600, the inverter unit 10, and the terminal unit 700 are arranged. Accordingly, the conductive path passing the U-phase portion 10U, the conductive path passing the V-phase portion 10V, and the conductive path passing the W-phase portion 10W all extend along the X-axis direction. Accordingly, these three conductive paths all become short, and the electrical resistance of each of the three conductive paths is reduced. This consequently allows reducing the loss of electric energy also in the case where electric power is supplied to the respective phases of the U-phase, the V-phase, and the W-phase of the motor 14, thus more efficiently supplying electricity to the motor 14.

Here, in this embodiment, in a view from the Z-axis direction, the busbars 608 and 610, the busbars 604 and 608 of the capacitor unit 600, the U-phase portion 10U, the V-phase portion 10V, and the W-phase portion 10W of the inverter unit 10, and the busbars 704U, 704V, and 704W of the terminal unit 700 are approximately line-symmetrical with the virtual straight line extending along the X-axis direction.

In this embodiment, the electric-current measurers 706U, 706V and 706W, which measure the electric currents flowing through the busbars 704U, 704V, and 704W, are arranged in the vicinity of the one ends of the busbars 704U, 704V, and 704W. These electric-current measurers 706U, 706V, and 706W are arranged on the end E2 side of the motor shaft 14d relative to the inverter unit 10 in the X-axis direction. Accordingly, the busbars 704U, 704V, and 704W need not be bypassed to arrange the electric-current measurers 706U, 706V and 706W in the busbars 704U, 704V, and 704W. Therefore, this allows further shortening the conductive path.

In this embodiment, in the completed state of the driving device 3, the tips of the busbars 608 and 610 are exposed to the outside of the housing case 500 through the opening portion 500b. Accordingly, the battery 2 can be simply coupled to the tips of the busbars 608 and 610.

In this embodiment, the inverter unit 10 is positioned between the motor 14 and the controller 18. That is, the controller 18 is positioned on the opposite side to the motor 14 with respect to the inverter unit 10. Accordingly, the controller 18 is positioned on the outer side of the driving device 3 relative to the inverter unit 10. Therefore, the signal line SG3 coupling the controller 18 and the VCU 1 together becomes likely to be guided to the outer side of the driving device 3. Accordingly, the controller 18 and the VCU 1 can be simply coupled together using the signal line SG3.

In this embodiment, in the X-axis direction, the controller 18 is positioned on the inverter unit 10 side relative to the busbars 608 and 610 (and the busbars 604p and 606n). Furtheimore, the signal input/output unit 18a disposed in the controller 18 is positioned in the region on the side apart from the busbars 608 and 610 (and the busbars 604p and 606n) in the X-axis direction in the controller 18. That is, the signal input/output unit 18a is positioned in the region apart from the busbars 608 and 610, to which electric power is supplied, in the controller 18. Accordingly, noise is less likely to contaminate the electrical signal input and output to/from the controller 18 via the signal input/output unit 18a.

In this embodiment, the parts (the capacitor unit 600, the inverter unit 10, and the terminal unit 700) inside the inverter housing portion 300 are arranged along the X-axis direction. Furthermore, the flow passage 10h extends along the Y-axis direction. Accordingly, the arrangement direction of the parts inside the inverter housing portion 300 is perpendicular to the extending direction of the flow passage 10h. Therefore, this allows restraining the interference between the parts inside the inverter housing portion 300 and the flow passage 10h. Furthermore, because the inverter unit 10 is cooled by the flow passage 10h, the flow passage 10h and the inverter unit 10 can be close to each other. This consequently allows shortening the flow passage 10h and arranging the parts inside the inverter housing portion 300 close to one another. Thus, the driving device 3 can be further downsized.

In this embodiment, in the coupling portion 106, the terminal unit 400 is positioned between the connector 108 and the connector 110. Accordingly, the signal lines SG1 and SG2 to be coupled to the connectors 108 and 110 are wired apart from the terminal unit 400. Accordingly, also in the case where high electric currents at high voltages flow through the busbars 404U, 404V, and 404W of the terminal unit 400, noise is less likely to occur in the electrical signals flowing through the signal lines SG1 0and SG2. This allows restraining the possibility of malfunction of the driving device 3.

### [6] Other Embodiments

The embodiment of the present disclosure has been described in detail above. Various modifications may be made to the above-described embodiment within the scope of the gist of the present disclosure. For example, in this embodiment, the electric vehicle EV has been described as one example of the vehicle. The driving device 3 according to this embodiment may be mounted on various vehicles that are driven using the rotational force of the motor to move on land, at sea, under the sea, or in the air. Examples of the vehicle that moves on land include, for example, a bike or an automobile having two or more wheels and a crawler vehicle that moves by rolling of track wheels on an endless track. Examples of the vehicle that moves at sea or under the sea include, for example, various ships, a personal water craft, a submarine, and an underwater bike. Examples of the vehicle that moves in the air include, for example, various aircrafts.

Instead of an inverter device (a power conversion apparatus) including the inverter unit 10, which converts a DC power into an AC power, other power conversion apparatuses may be used. The other power conversion apparatuses include, for example, a matrix converter device that converts an input AC power into an AC power having different amplitude and/or frequency and outputs the converted AC power, a DC-DC converter device that converts an input DC voltage into a DC voltage having a different magnitude and outputs the converted DC voltage, and a power conversion apparatus that is driven by an electronic component such as a semiconductor switch element.

In this embodiment, the driving device 3 includes the AC motor 14 having three phases. Instead, the driving device 3 may include the AC motor 14 having a single phase. In this case, the motor 14 is rotatably driven based on the AC powers in any two phases of the U-phase, the V-phase, and the W-phase. Accordingly, the driving device 3 need not include the member related to the phase that is not used in the above-described embodiment.

In this embodiment, the motor 14 includes the two winding wires 14a and 14b for high-speed driving and for low-speed driving. Instead, the motor 14 may include one of the winding wires alone.

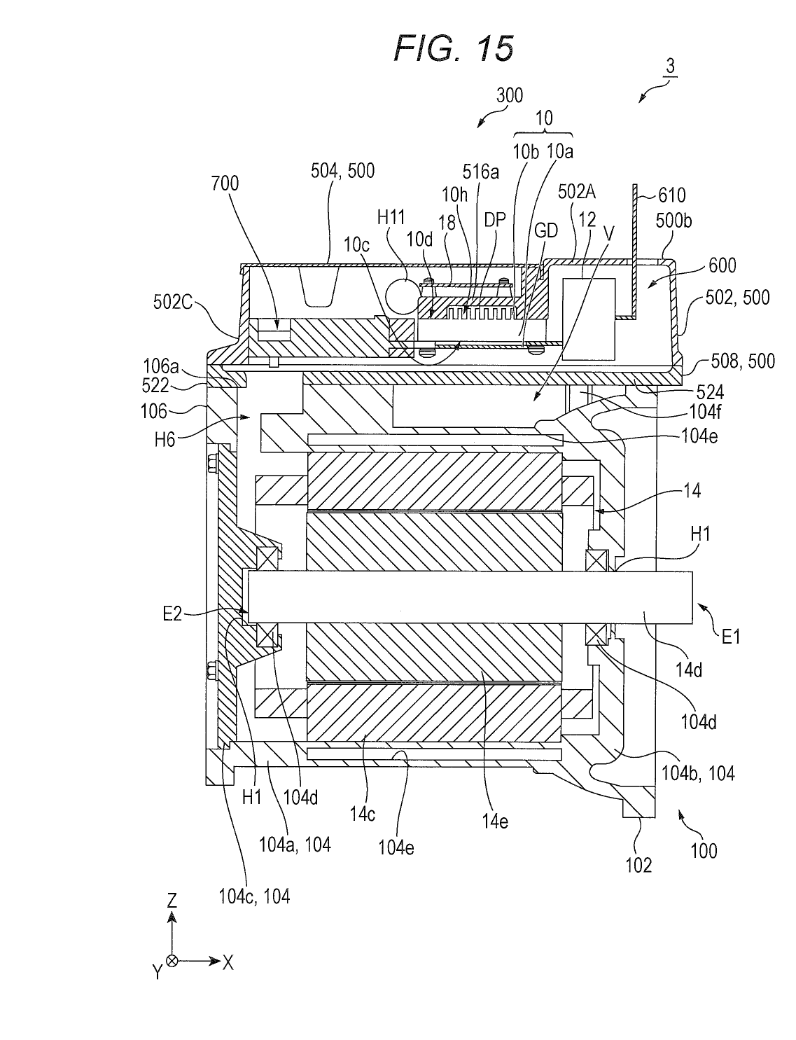

As illustrated in FIG. 15, the driving device 3 need not include the winding-wire switching/housing portion 200 which houses the winding-wire switcher 16.

The method for switching the winding wire by the winding-wire switcher 16 is not limited to the above-described method for electrically connecting the winding wires 14a and 14b together in series, but can employ other methods. The circuit of the winding-wire switcher 16 may be, for example, a circuit constituted as a 6-in-1 or 2-in-1 module.

The flow passage 10h may be positioned between the inverter unit 10 and the motor 14. That is, in the Z-axis direction, the motor 14, the flow passage 10h, and the inverter unit 10 may be arranged in this order. Similarly, the flow passage 16g may be positioned between the winding-wire switcher 16 and the lid portion 206. That is, in the X-axis direction, the winding-wire switcher 16, the flow passage 16g, and the lid portion 206 may be arranged in this order.

The extending directions of the flow passages 10h and 16g are not limited to the Y-axis direction. Specifically, the flow passages 10h and 16g may have a straight shape or may be, for example, accordion-folded.

The flow passage 104e may have a shape other than an annular shape. Specifically, the flow passage 104e may be, for example, accordion-folded surrounding the motor 14.

The cooling liquid for cooling the inverter unit 10, the motor 14, and the winding-wire switcher 16 may employ, for example, water or another liquid.

While in this embodiment the busbars are used for physically and electrically coupling the capacitor 12, the inverter unit 10, and the motor 14 together, conductive members (such as lead wires) other than the busbars may be used.

At least two selected from the housing case 102 of the motor housing portion 100, the housing case 202 of the winding-wire switching/housing portion 200, and the housing case 500 of the inverter housing portion 300 may be integrally combined or may be integrally molded not to be mutually removable.

In the case where the driving device 3 is mounted on the electric vehicle EV such that the motor 14 as a heavy load is positioned on the lower side, the battery 2 may be arranged in the portion other than on the inverter housing portion 300.

The driving device 3 need not have the busbars 608 and 610. In this case, for example, the tips of the busbars 604p and 606n may be directly coupled to the battery 2 by a conductive cable or the like.

The opening portion 500b may be formed on the side wall 512 instead of the bottom wall 510. In this case, the opening portion 500b may be formed in the position corresponding to the tips of the busbars 604p and 606n.

In this description, the expression “direction” includes not only a strictly matched direction but also a substantially matched direction (an approximate direction). The expression “perpendicular” includes not only a strictly perpendicular condition but also an substantially perpendicular condition.

It should be understood that the embodiments disclosed herein are merely an example in all the points of view and not intended to be restricted thereto. The scope of the present disclosure is represented not by the description of the embodiments described above but by the claims and, furthermore, includes all modifications within the scope of the claims and the equivalent thereof.

Here, the Z-axis direction is one example of the first direction.

The driving device of this embodiment may be the following first to eighth driving devices and first vehicle.

A first driving device includes: a motor including a winding wire; a first cooler configured to cool the motor; a power converter coupled to the motor; and a second cooler configured to cool the power converter. The motor, the first cooler, the power converter, and the second cooler are arranged in this order along the first direction.

A second driving device according to the first driving device further includes a controller configured to control an operation of the power converter. The motor, the first cooler, the power converter, the second cooler, and the controller are arranged in this order along the first direction.

A third driving device according to the first or second driving device further includes: a first housing portion that includes a first cooler and internally houses the motor such that a motor shaft of the motor has an outwardly projecting end on a load side coupled to an external load; and a second housing portion that includes a second cooler and internally houses the power converter. The first and second housing portions are integrally combined through a first coupling portion of the first housing portion and a second coupling portion of the second housing portion. The first direction is a direction perpendicular to a second direction in which the motor shaft extends.

In a fourth driving device according to the third driving device, the first and second housing portions are integrally combined through the first coupling portion and the second coupling portion on an opposite side to the end of the motor shaft.

A fifth driving device according to the third or fourth driving device further includes a conductive member electrically coupling the power converter and the motor together. The first coupling portion has a first opening portion opened toward the second coupling portion. The second coupling portion has a second opening portion opened toward the first coupling portion. The first and second opening portions correspond to each other to communicate between the first and second housing portions in a state where the first and second housing portions are integrally combined. The conductive member is inserted through the first and second opening portions.

In a sixth driving device according to any one of the third to fifth driving devices, at least parts of the first housing portion and the second housing portion are separated from one another on the end side of the motor shaft relative to the first and second coupling portions.

A seventh driving device according to any one of the third to sixth driving devices further includes a winding-wire switcher configured to switch a connection state of a first winding wire and a second winding wire of the winding wire. The winding-wire switcher is arranged on an outer side of the first housing portion and on an opposite side to the end in the motor shaft.

An eighth driving device according to the seventh driving device further includes a third cooler arranged between the first housing portion and the winding-wire switcher.

A first vehicle includes any one of the first to eighth driving devices.

These driving devices or vehicle allow reducing the influence of heat on the inverter and the motor.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example fonds of implementing the claims appended hereto.

What is claimed is:

1. A driving device comprising:
a motor including a winding wire;
a first cooler configured to cool the motor; and
a power converter coupled to the motor, wherein
the motor, the first cooler, and the power converter are arranged in this order along a first direction.

2. The driving device according to claim 1, further comprising
a second cooler configured to cool the power converter, wherein
the motor, the first cooler, the power converter, and the second cooler are arranged in this order along the first direction.

3. The driving device according to claim 2, further comprising
a controller configured to control an operation of the power converter, wherein
the motor, the first cooler, the power converter, the second cooler, and the controller are arranged in this order along the first direction.

4. The driving device according to claim 2, further comprising:
a first housing portion including the first cooler, the first housing portion housing the motor such that a motor shaft of the motor has an outwardly projecting end on a load side coupled to an external load; and
a second housing portion including the second cooler, the second housing portion housing the power converter, wherein
the first housing portion and the second housing portion are integrally combined through a first coupling portion of the first housing portion and a second coupling portion of the second housing portion, and
the first direction is a direction perpendicular to a second direction in which the motor shaft extends.

5. The driving device according to claim 3, further comprising:
a first housing portion including the first cooler, the first housing portion housing the motor such that a motor shaft of the motor has an outwardly projecting end on a load side coupled to an external load; and
a second housing portion including the second cooler, the second housing portion housing the power converter, wherein
the first housing portion and the second housing portion are integrally combined through a first coupling portion of the first housing portion and a second coupling portion of the second housing portion, and
the first direction is a direction perpendicular to a second direction in which the motor shaft extends.

6. The driving device according to claim 4, wherein
the first and second housing portions are integrally combined through the first coupling portion and the second coupling portion on an opposite side to the end of the motor shaft.

7. The driving device according to claim 5, wherein
the first and second housing portions are integrally combined through the first coupling portion and the second coupling portion on an opposite side to the end of the motor shaft.

8. The driving device according to claim 4, further comprising
a conductive member electrically coupling the power converter and the motor, wherein
the first coupling portion has a first opening portion opened toward the second coupling portion,
the second coupling portion has a second opening portion opened toward the first coupling portion,
the first and second opening portions correspond to each other to communicate the first and second housing portions each other in a state where the first and second housing portions are integrally combined, and
the conductive member is inserted through the first and second opening portions.

9. The driving device according to claim 5, further comprising
a conductive member electrically coupling the power converter and the motor, wherein
the first coupling portion has a first opening portion opened toward the second coupling portion,
the second coupling portion has a second opening portion opened toward the first coupling portion,
the first and second opening portions correspond to each other to communicate the first and second housing portions each other in a state where the first and second housing portions are integrally combined, and
the conductive member is inserted through the first and second opening portions.

10. The driving device according to claim 6, further comprising
a conductive member electrically coupling the power converter and the motor, wherein
the first coupling portion has a first opening portion opened toward the second coupling portion,
the second coupling portion has a second opening portion opened toward the first coupling portion,
the first and second opening portions correspond to each other to communicate the first and second housing portions each other in a state where the first and second housing portions are integrally combined, and
the conductive member is inserted through the first and second opening portions.

11. The driving device according to claim 7, further comprising
a conductive member electrically coupling the power converter and the motor, wherein
the first coupling portion has a first opening portion opened toward the second coupling portion,
the second coupling portion has a second opening portion opened toward the first coupling portion,
the first and second opening portions correspond to each other to communicate the first and second housing portions each other in a state where the first and second housing portions are integrally combined, and
the conductive member is inserted through the first and second opening portions.

12. The driving device according to claim 4, wherein
at least parts of the first housing portion and the second housing portion are separated from one another on the end side of the motor shaft relative to the first and second coupling portions.

13. The driving device according to claim 4, further comprising
a winding-wire switcher configured to switch a connection state of a first winding wire and a second winding wire in the winding wire, wherein
the winding-wire switcher is arranged on an outer side of the first housing portion and on an opposite side to the end of the motor shaft.

14. The driving device according to claim 13, further comprising
a third cooler arranged between the first housing portion and the winding-wire switcher.

15. The driving device according to claim 13, wherein
the third cooler is arranged between the first cooler and the second cooler in a refrigerant flow passage.

16. A vehicle comprising
the driving device according to claim 1.
